(19) United States
(12) Patent Application Publication
(10) Pub. No.: US 2025/0365383 A1
(43) Pub. Date: Nov. 27, 2025

(54) IMAGE FORMING SYSTEM, METHOD FOR CONTROLING IMAGE FORMING SYSTEM, AND RECORDING MEDIUM

(71) Applicant: Konica Minolta, Inc., Tokyo (JP)

(72) Inventor: Shu YABUUCHI, Tokyo (JP)

(21) Appl. No.: 19/209,084

(22) Filed: May 15, 2025

(30) Foreign Application Priority Data
May 24, 2024 (JP) 2024-084711

(51) Int. Cl. H04N 1/60

(52) U.S. Cl. CPC H04N 1/6008; H04N 1/6033

(57) ABSTRACT

Disclosed is an image forming system including: an image forming section that forms an image on a recording medium; a reading section that reads the image formed on the recording medium; a colorimetry section that is disposed downstream of the reading section in a conveyance direction of the recording medium, and performs colorimetry on a color adjustment chart formed on the recording medium; and a hardware processor that controls the colorimetry section based on the image read by the reading section.

### BACKGROUND OF THE INVENTION

### Technical Field

The present invention relates to an image forming system, a method for controlling an image forming system, and a recording medium.

### Description of Related Art

An image forming system includes an image forming apparatus that forms an image on a sheet, and a sheet feed device that feeds a sheet to the image forming apparatus. The image forming apparatus forms an image on a sheet based on output job information. In recent years, printing accuracy has been improved by measuring color information of a printed material by a colorimetry section and correcting an image forming operation of an image forming section based on the measured information.

As a conventional technique relating to this kind of colorimetry section, for example, there is a technique described in JP 2015-152551A. JP 2015-152551A describes a technique that includes an acquisition section that performs colorimetry on a color patch to acquire at least two colorimetric values, and a first determination section that determines, from the at least two colorimetric values, whether the measured color patch is to be subjected to colorimetry.

Furthermore, by increasing the number of color patches in a color adjustment chart, it is possible to perform highly precise color correction.

### SUMMARY OF THE INVENTION

However, as the number of color patches in a color adjustment chart increases, it takes a long time for a colorimetry section to perform a colorimetry operation. Furthermore, in the technology described in JP 2015-152551A, in order to determine whether a colorimetry result is an error, it is necessary to actually perform colorimetry on a color patch in a color adjustment chart by operating a colorimetry section. As a result, in the technology described in JP 2015-152551A, it is necessary to operate the colorimetry section even when the colorimetry result is an error, which leads to a problem that the processing time of the entire system becomes long.

In consideration of the above-described conventional problems, it is an object of the present invention to provide an image forming system, a method for controlling an image forming system, and a recording medium capable of achieving reduction in the processing time of the entire system.

To achieve at least one of the abovementioned objects, an image forming system reflecting one aspect of the present invention comprises: an image forming section that forms an image on a recording medium; a reading section that reads an image formed on the recording medium; a colorimetry section that is disposed downstream of the reading section in a conveyance direction of the recording medium, and performs colorimetry on a color adjustment chart formed on the recording medium; and a hardware processor that controls the colorimetry section based on the image read by the reading section.

To achieve at least one of the abovementioned objects, a method for controlling an image forming system reflecting another aspect of the present invention comprises: forming an image of a color adjustment chart on a recording medium; reading the image formed on the recording medium by a reading section; and controlling a colorimetry section based on the image read by the reading section, the colorimetry section being disposed downstream of the reading section in a conveyance direction of the recording medium and being configured to perform colorimetry on the color adjustment chart formed on the recording medium.

To achieve at least one of the abovementioned objects, a recording media reflecting still another aspect of the present invention is a non-transitory computer-readable recording medium storing a program executable by a computer, the program causing an image forming system to execute: causing an image forming section to form an image of a color adjustment chart on a recording medium; causing a reading section to read the image formed on the recording medium; and controlling a colorimetry section based on the image read by the reading section, the colorimetry section being disposed downstream of the reading section in a conveyance direction of the recording medium and being configured to perform colorimetry on the color adjustment chart formed on the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic configuration diagram illustrating a whole configuration of an image forming system according to an embodiment of the present invention;

FIG. 2 is a block diagram illustrating a hardware configuration of the image forming system according to the embodiment of the present invention;

FIG. 3 is an explanatory diagram illustrating a colorimetry operation of a colorimetry section according to the embodiment of the present invention;

FIG. 4 is a flowchart illustrating a colorimetry operation of the image forming system according to the embodiment of the present invention;

FIG. 5 is a flowchart illustrating a patch measurement process of the image forming system according to the embodiment of the present invention;

FIG. 6A and FIG. 6B are diagrams each illustrating, in the image forming system according to the embodiment of the present invention, an image formed on a sheet with a patch size smaller than a predetermined size or in a high-precision colorimetry mode;

FIG. 6A illustrates an ideal printing position, and FIG. 6B illustrates an image when a printing displacement occurs;

FIG. 7 is an explanatory diagram illustrating a method for calculating a feature point in the image forming system according to the embodiment of the present invention;

FIG. 8 is a diagram illustrating coordinates of four corners of a color adjustment chart in the image forming system according to the embodiment of the present invention;

FIG. 9 is a diagram illustrating, in the image forming system according to the embodiment of the present invention, an image formed on a sheet with a patch size larger than the predetermined size or not in the high-precision colorimetry mode;

FIG. 10A and FIG. 10B are explanatory diagrams illustrating a modification example of the feature point in the image forming system according to the embodiment of the present invention; and

FIG. 10A illustrates an ideal printing position, and FIG. 10B illustrates an image when a printing displacement occurs.

### DETAILED DESCRIPTION

Hereinafter, one or more embodiments of the present invention will be described with reference to the drawings. However, the scope of the invention is not limited to the disclosed embodiments. In the drawings, common members are denoted by the same reference numerals.

### 1. Embodiment

### 1-1. Configuration of Image Forming System

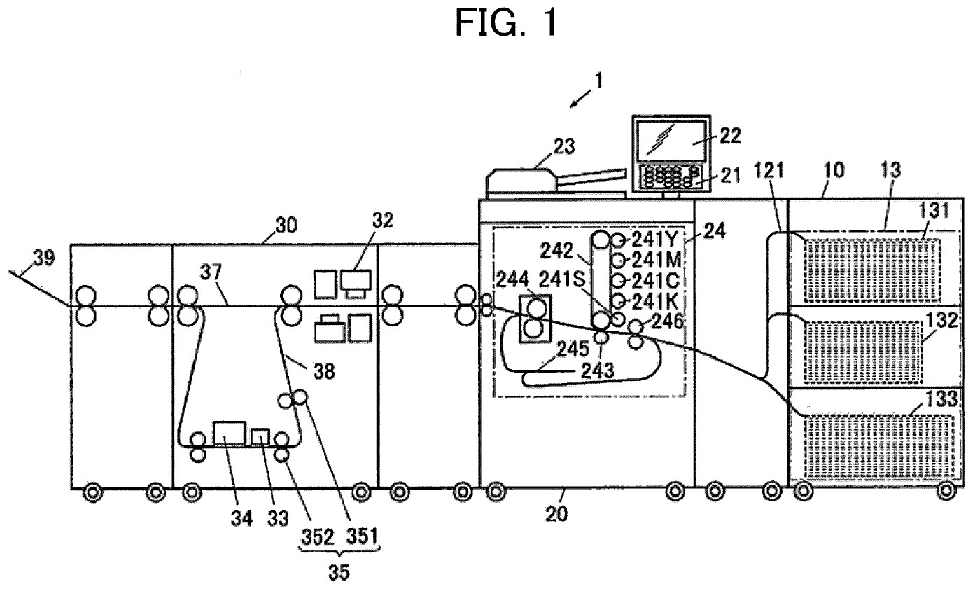

First, an overall configuration of an image forming system according to an embodiment of the present invention (hereinafter, referred to as “present embodiment”) will be described. FIG. 1 is a schematic configuration diagram illustrating an image forming system 1 according to the present embodiment.

As illustrated in FIG. 1, the image forming system 1 includes a sheet feed device 10, an image forming apparatus 20, and an image reading device 30. The sheet feed device 10, the image forming apparatus, and the image reading device 30 are each coupled to a network such as a LAN and are coupled to each other via the network. Furthermore, in the image forming system 1, the sheet feed device 10, the image forming apparatus 20, and the image reading device 30 are disposed in this order from the upstream of a conveyance route of a sheet S and are connected in series.

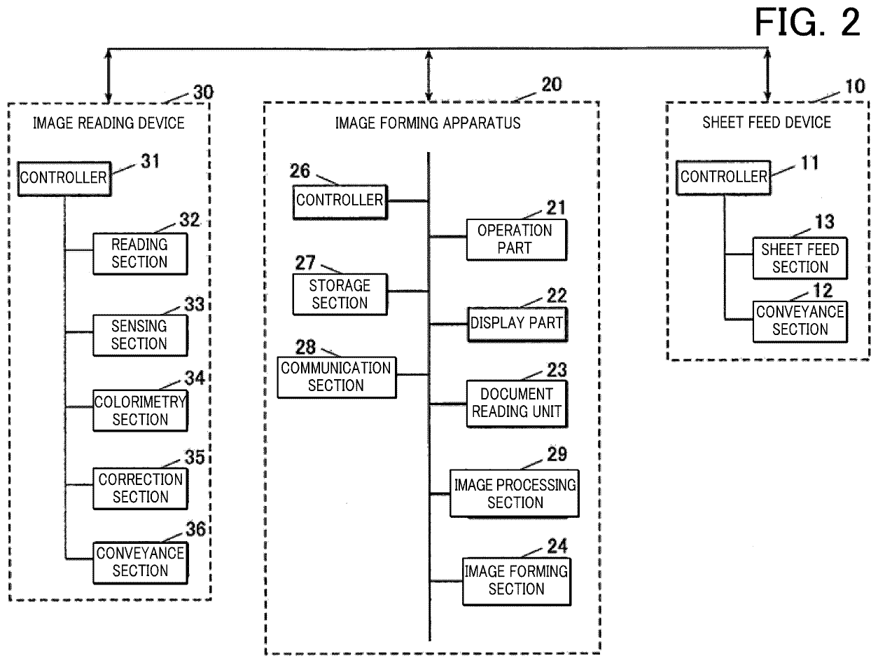

The sheet feed device 10 includes a sheet feed section 13 including a plurality of sheet feed trays 131, 132, and 133, and a conveyance section 12 that conveys a sheet accommodated in the sheet feed section 13 (see FIG. 2). The number of sheet feed trays 131, 132, and 133 constituting the sheet feed section 13 is not limited to three, and may be two, four, or more. The conveyance section 12 includes a conveyance path 121 communicating with the image forming apparatus 20. The conveyance section 12 conveys a sheet to the image forming apparatus 20 via the conveyance path 121.

The image forming apparatus 20 forms an image on a roll sheet S by an electrophotographic method and is a tandem-type color image forming apparatus that superimposes four color toners of yellow (Y), magenta (M), cyan (C), and black (K). The image forming apparatus 20 includes an operation part 21, a display part 22, a document reading unit 23, and an image forming section 24.

The operation part 21 and the display part 22 are installed on top of a housing of the image forming apparatus 20. The operation part 21 and the display part 22 are, for example, a touch screen including a display such as a liquid crystal display (LCD) or an organic electro luminescence display (ELD). The display part 22 displays an instruction menu for a user, information about acquired image data, and the like. Further, the operation part 21 includes a plurality of keys, receives input of data such as various instructions, characters, and numerals by key operation of the user, and outputs an input signal to a controller 26 (hardware processor). In addition, the display part 22 displays various reports, feedback information, and the like indicating inspection results of the image reading device 30, which will be described later.

The document reading unit 23 includes a document feed table on which a document is to be set, a document ejection tray, a plurality of rollers, and a document reading section. A document set on the document feed table is conveyed one sheet at a time to a reading position of the document reading section by the plurality of rollers. A document read by the document reading section is ejected into the document ejection tray.

The document reading section reads an image of a conveyed document or a document placed on the document feed table and generates image data. An image on one side or both sides of the document conveyed to the document reading section is exposed by an optical system and read by an image sensor.

An analog signal photoelectrically converted by the image sensor is subjected to various kinds of processing in an image processing section 29 (see FIG. 2), such as analog processing, A/D conversion processing, shading correction processing, and image compression processing. Then, the image signal on which various kinds of signal processing have been performed is sent from the image processing section 29 to the image forming section 24.

Note that the image signal sent to the image forming section 24 is not limited to the image signal output from the document reading unit 23 but may be an image signal received from an external device such as a personal computer or another image forming apparatus connected to the image forming apparatus 20.

The image forming section 24 includes four image forming units 241Y, 241M, 241C, and 241K, a conveyance section 246, an intermediate transfer belt 242, a secondary transfer section 243, a fixing section 244, and a reversing conveyance section 245. The image forming section 24 forms toner images of respective colors of yellow (Y), magenta (M), cyan (C), and black (K) by the four image forming units 241Y, 241M, 241C, and 241K.

A first image forming unit 241Y forms a yellow toner image, and a second image forming unit 241M forms a magenta toner image. A third image forming unit 241C forms a cyan toner image and a fourth image forming unit 241K forms a black toner image. Since the four image forming units 241Y, 241M, 241C, and 241K have the same configuration, the first image forming unit 241Y will be described as a representative example.

The first image forming unit 241Y includes a drum-shaped photoreceptor, a charging section disposed around the photoreceptor, an exposure section, a developing section, and a cleaning device. The photoreceptor is rotated counterclockwise by a drive motor (not illustrated). The charging section applies an electric charge to the photoreceptor to uniformly charge the surface of the photoreceptor. Based on externally transmitted image data, the exposure section performs scanning exposure on the surface of the photoreceptor to form an electrostatic latent image on the photoreceptor.

The developing section attaches yellow toner to the electrostatic latent image formed on the photoreceptor. Thus, a yellow toner image is formed on the surface of the photoreceptor. Note that the developing section of the second image forming unit 241M attaches magenta toner to the photoreceptor, and the developing section of the third image forming unit 241C attaches cyan toner to the photoreceptor. Then, the developing section of the fourth image forming unit 241K attaches black toner to the photoreceptor.

The toner attached to the photoreceptor is transferred onto the intermediate transfer belt 242. The cleaning device removes toner remaining on the surface of the photoreceptor after the transfer to the intermediate transfer belt 242.

The intermediate transfer belt 242 is formed in an endless shape and is rotated by a drive motor (not shown) in a clockwise direction opposite to the rotation direction of the photoreceptor. In the intermediate transfer belt 242, primary transfer sections are disposed at positions facing the photoreceptors of the respective image forming units 241Y, 241M, 241C, and 241K. Each of the primary transfer sections transfers the toner image formed on the photoreceptor to the intermediate transfer belt 242 by applying a polarity opposite to that of the toner to the intermediate transfer belt 242.

As the intermediate transfer belt 242 rotates, the toner images formed by the four image forming units 241Y, 241M, 241C, and 241K are sequentially transferred onto the intermediate transfer belt 242. Thus, the yellow, magenta, cyan, and black toner images overlap each other on the intermediate transfer belt 242 to form a color image.

The secondary transfer section 243 is disposed adjacent to the intermediate transfer belt 242 and downstream of the conveyance section 246 in a conveyance direction. The secondary transfer section 243 includes a transfer roller pair including an upper transfer roller around which the intermediate transfer belt 242 is stretched and a lower transfer roller pressed against the upper transfer roller with the intermediate transfer belt 242 interposed therebetween. The upper transfer roller and the lower transfer roller constituting the secondary transfer section 243 are configured to be able to come into pressure contact with and separate from each other with the intermediate transfer belt 242 interposed therebetween.

In the secondary transfer section 243, a sheet conveyed from the conveyance section 246 is pressed against the intermediate transfer belt 242 by the lower transfer roller. Then, the secondary transfer section 243 transfers the color toner image formed on the intermediate transfer belt 242 onto the sheet sent from the conveyance section 246.

The fixing section 244 is disposed downstream of the secondary transfer section 243 in the conveyance direction. The fixing section 244 includes a fixing belt and a pressure roller that is a pressure member. The fixing belt is formed of an endless elastic member and is supported and stretched by a fixing roller as a drive roller and a heating roller as a driven roller.

A fixing nip is formed at a portion where the fixing roller and the pressure roller are in contact with each other via the fixing belt. When the sheet bearing the toner image passes through the fixing nip of the fixing section 244, the toner is melted by the fixing belt and the pressure roller controlled at a predetermined temperature and is fixed onto the sheet.

The sheet on which the fixing processing has been performed by the fixing section 244 is conveyed to the reversing conveyance section 245 and the image reading device 30 by the conveyance section 246.

The reversing conveyance section 245 includes a reversing section that reverses a sheet. The sheet whose front and back sides or top and bottom sides have been reversed by the reversing section is conveyed upstream of the secondary transfer section 243 or downstream of the fixing section 244 through the reversing conveyance section 245.

The image reading device 30 reads an image formed on a sheet. The image reading device 30 also performs colorimetry on a correction patch formed on a sheet. The image reading device 30 includes a conveyance section 36 that conveys a sheet (see FIG. 2), a reading section 32, a sensing section 33, a colorimetry section 34, a correction section 35, and a sheet ejection tray 39. The conveyance section 36 includes a first conveyance section 37 and a second conveyance section 38.

The reading section 32 is disposed upstream of the image reading device 30 in the conveyance direction. The reading section 32 reads an image formed on a sheet conveyed from the image forming apparatus 20. The conveyance section 36 is branched into the first conveyance section 37 and the second conveyance section 38 downstream of the reading section 32 in the conveyance direction. The first conveyance section 37 conveys a sheet toward the sheet ejection tray 39.

The correction section 35, the sensing section 33, and the colorimetry section 34 are disposed in the second conveyance section 38. The correction section 35 includes first conveyance rollers 351 and second conveyance rollers 352. The correction section 35 corrects the orientation of a sheet conveyed by the first conveyance rollers 351 and the second conveyance rollers 352.

The sensing section 33 is disposed downstream of the correction section 35 in the conveyance direction in the second conveyance section 38. The sensing section 33 detects a sheet that has passed through the second conveyance section 38 and reached the sensing section 33. The colorimetry section 34 is disposed downstream of the sensing section 33 in the conveyance direction. The colorimetry section 34 performs colorimetry on a patch formed on the sheet that has passed through the sensing section 33. The sheet that has passed through the colorimetry section 34 is conveyed to the sheet ejection tray 39 by the second conveyance section 38.

### 1-2. Hardware Configuration of Each Device

Next, a hardware configuration of each device will be described with reference to FIG. 2.

FIG. 2 is a block diagram illustrating a hardware configuration of each device of the image forming system.

First, a hardware configuration of the sheet feed device 10 will be described.

As illustrated in FIG. 2, the sheet feed device 10 includes a controller 11 (hardware processor), the sheet feed section 13, and the conveyance section 12. The controller 11 includes, for example, a central processing unit (CPU). The controller 11 controls the sheet feed section 13 and the conveyance section 12 to feed a sheet of a predetermined size from sheets accommodated in the sheet feed trays 131, 132, and 133 toward the image forming apparatus 20.

Next, a hardware configuration of the image forming apparatus 20 will be described.

The image forming apparatus 20 includes the operation part 21, the display part 22, the document reading unit 23, the controller 26, a storage section 27, a communication section 28, and the image processing section 29. The controller 26 includes, for example, a central processing unit (CPU). The controller 26 is coupled to the operation part 21, the display part 22, the document reading unit 23, the storage section 27, the communication section 28, and the image processing section 29 via a system bus and controls the entire image forming apparatus 20. In addition, the controller 26 corrects an image forming operation of the image forming section 24 based on a reading result of the image reading device 30 to be described later.

The storage section 27 is a volatile memory such as a RAM or a large-capacity nonvolatile memory. The storage section 27 stores a program or the like executed by the controller 26 and is used as a workspace of the controller 26.

The image processing section 29 acquires image data and attribute data from job information input from the outside and performs image processing. The image processing section 29 performs image processing such as shading correction, image density adjustment, and image compression on the acquired image data in accordance with the attribute data and the job information under the control of the controller 26. The image data processed by the image processing section 29 is then transmitted to the image forming section 24. The image forming section 24 receives the image data subjected to the image processing by the image processing section 29 and forms an image on a sheet based on the image data.

The communication section 28 transmits and receives data to and from the sheet feed device 10, the image reading device 30, and the like. Then, the communication section 28 outputs various data such as received image data and attribute data to the controller 26.

Next, a hardware configuration of the image reading device 30 will be described.

The image reading device 30 includes a controller 31 (hardware processor), the reading section 32, the sensing section 33, the colorimetry section 34, the correction section 35, and the conveyance section 36. The controller 31 includes, for example, a central processing unit (CPU). The controller 31 is coupled to the reading section 32, the sensing section 33, the colorimetry section 34, the correction section 35, and the conveyance section 36 via a system bus and controls the entire image reading device 30.

The reading section 32 reads (captures) an image formed on a sheet conveyed from the image forming apparatus 20. The reading section 32 outputs the read image information to the controller 31. The controller 31 controls the operations of the colorimetry section 34, the correction section 35, and the conveyance section 36 based on the image information received from the reading section 32. The conveyance section 36 switches between conveying a sheet to the first conveyance section 37 and conveying a sheet to the second conveyance section 38 based on a control signal from the controller 31.

The colorimetry section 34 performs colorimetry on a patch formed on a sheet based on a control signal from the controller 31. Then, the colorimetry section 34 outputs a colorimetry result to the controller 31.

In the image forming system 1 according to the present embodiment, the controllers 11, 26, and 31 are provided in the sheet feed device 10, the image forming apparatus 20, and the image reading device 30, respectively, but the present invention is not limited thereto. For example, one controller (hardware processor) that controls the entire image forming system 1 may be provided.

### 2. Colorimetry Operation of Colorimetry Section

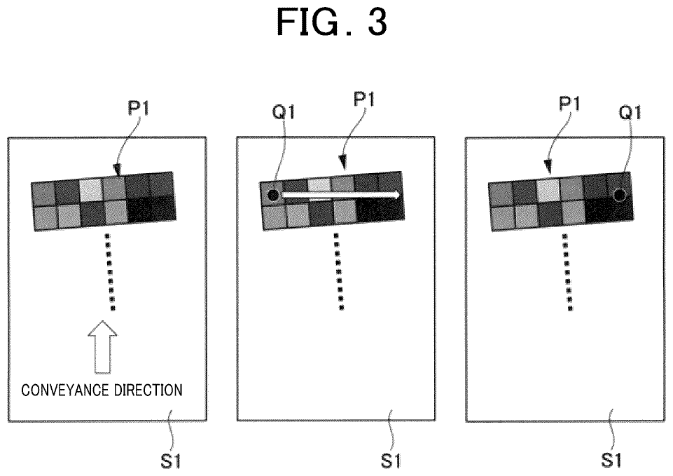

Next, a colorimetry operation of the colorimetry section 34 will be described with reference to FIG. 3.

FIG. 3 is an explanatory diagram illustrating a colorimetry operation of the colorimetry section 34.

As illustrated in FIG. 3, when the colorimetry section 34 performs a colorimetry operation, the controller 26 of the image forming apparatus 20 controls the image forming section 24 to form a color adjustment chart P1 in a plurality of colors (patches) on a sheet S1. The plurality of color patches forming the color adjustment chart P1 are printed side by side along a scanning direction orthogonal to the conveyance direction of the sheet S1 and the conveyance direction.

When the sheet S1 reaches the colorimetry section 34, the controller 31 of the image reading device 30 moves a sensing section of the colorimetry section 34 in the scanning direction. Therefore, as illustrated in FIG. 3, a detection point Q1 of the colorimetry section 34 moves along the scanning direction to perform colorimetry on the color adjustment chart P1 formed in the plurality of colors on the sheet S1.

Here, when the color adjustment chart P1 is formed on the sheet S1 with an inclination, the direction in which the patches of the color adjustment chart P1 are aligned is also inclined with respect to the scanning direction of the colorimetry section 34. Therefore, the detection point Q1 of the colorimetry section 34 may pass over a patch different from the patch that is the original colorimetry target or may pass over the boundary between patches of two different colors. As a result, there is a problem in that the colorimetric accuracy of the colorimetry section 34 decreases or a colorimetric error occurs.

Note that in the image forming system 1 according to the present embodiment, an example has been described in which the sensing section of the colorimetry section 34 is moved in the scanning direction orthogonal to the conveyance direction of the sheet S1, but the direction in which the sensing section is moved is not limited thereto. For example, the sensing section of the colorimetry section 34 may be moved in two directions of the scanning direction and a sub-scanning direction orthogonal to the scanning direction or may be moved only in the sub-scanning direction. Furthermore, the sensing section of the colorimetry section 34 may be fixed. Note that a plurality of colors can be measured at once by moving the sensing section of the colorimetry section 34 in the scanning direction or the sub-scanning direction. As a result, a large amount of color information (patches) can be formed on the sheet S1 of a single sheet, a large amount of colorimetry data can be acquired with a small number of sheets, and highly precise color correction can be achieved.

Furthermore, when the number of patches to be subjected to colorimetry increases, it takes a long time to perform the colorimetry. Then, in order to shorten the time required for the colorimetry, it is preferable to reduce the size of patches to be formed on the sheet S1 of a single sheet. In addition, in a case where the size of patches is reduced, when the position of the color adjustment chart P1 is inclined, as described above, the colorimetric accuracy may decrease or a colorimetric error may occur.

### 3. Colorimetry Operation of Image Forming System

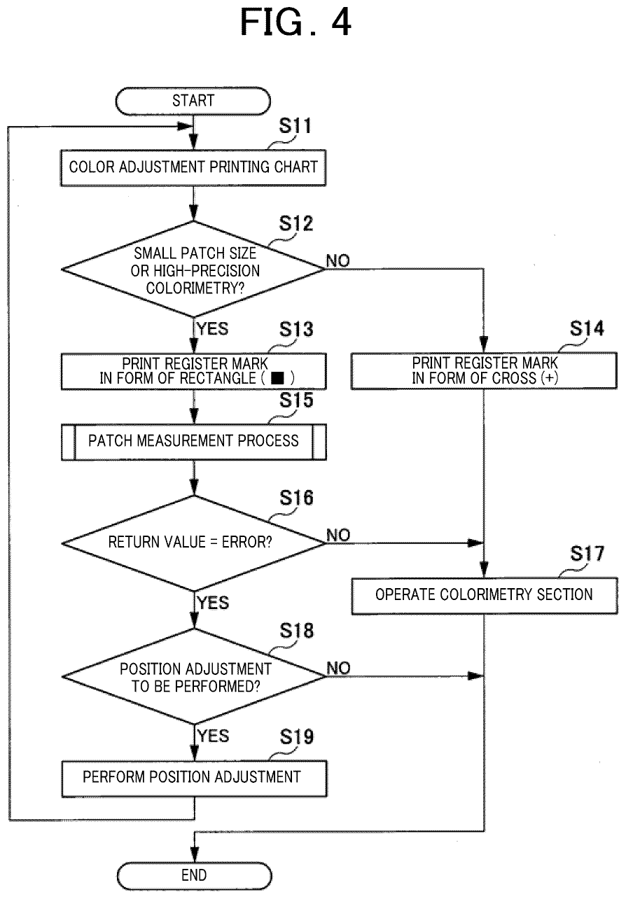

Next, a colorimetry operation of the image forming system 1 having the above-described configuration will be described with reference to FIGS. 4 to 9.

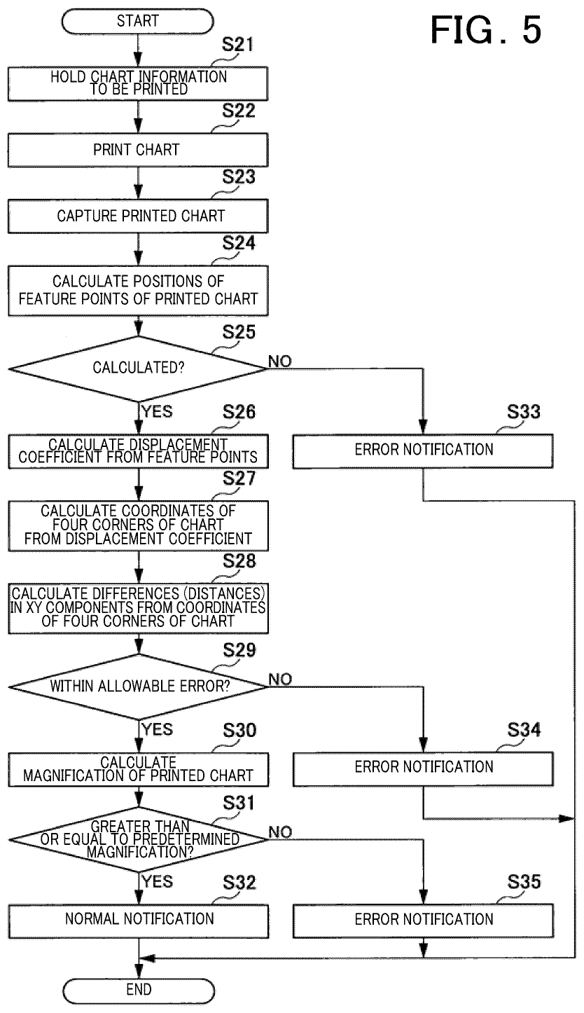

FIG. 4 is a flowchart illustrating a colorimetry operation, and FIG. 5 is a flowchart illustrating a patch measurement process.

As illustrated in FIG. 4, the controller 26 of the image forming apparatus 20 performs an colorimetry operation on a color adjustment printing chart in response to a user's instruction or every predetermined period of time (step S11). Next, the controller 26 determines a colorimetry mode (step S12). In the processing of step S12, the controller 26 determines, as the colorimetry mode, whether the patch size to be printed in the color adjustment chart is smaller than a predetermined size or the mode is the high-precision colorimetry mode (step S12).

If the controller 26 determines in the processing of step S12 that the patch size is smaller than the predetermined size or the mode is in the high-precision colorimetry mode (determination of YES in step S12), the controller 26 advances the process to step S13. In the processing of step S13, the controller 26 of the image forming apparatus 20 controls the image forming section 24 so as to print a register mark in the form of a rectangle as a predetermined first measurement image (first register mark T1). Then, the controller 26 advances the process to step S15.

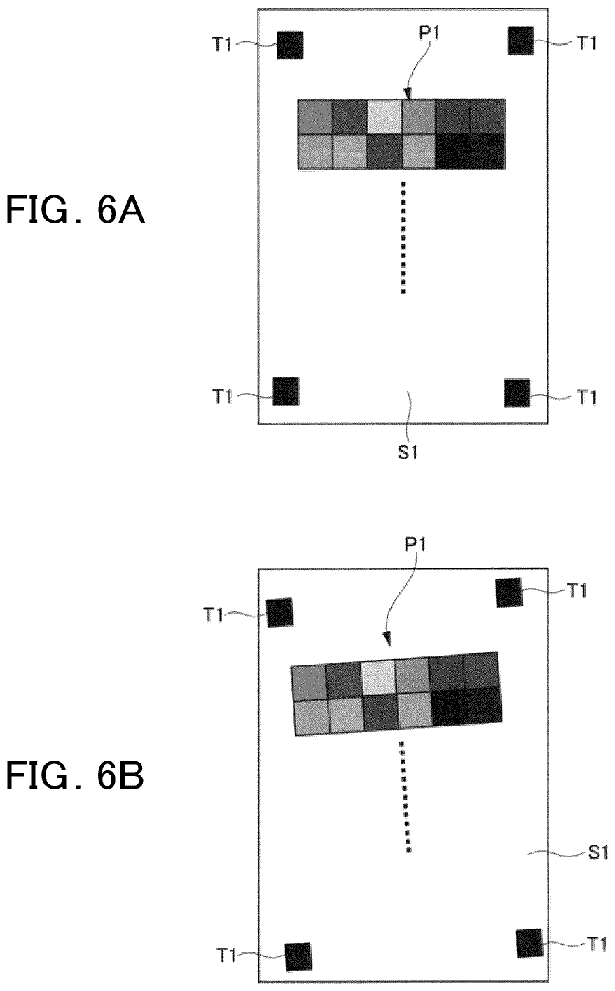

Each of FIG. 6A and FIG. 6B is a diagram illustrating an image formed on a sheet S1 with the patch size smaller than the predetermined size or in the high-precision colorimetry mode (second level). FIG. 6A illustrates an ideal printing position, and FIG. 6B illustrates an image when a printing displacement occurs.

As illustrated in FIG. 6A, when the patch size is smaller than the predetermined size or the colorimetry mode is the high-precision colorimetry mode, the color adjustment chart P1 and the first register marks T1 are printed on the sheet S1. The first register marks T1 are printed at the four corners of the sheet S1. Each of the first register marks T1 is printed as a solid black rectangular image. The first register mark T1 and the color adjustment chart P1 are formed at predetermined positions in the sheet S1.

As illustrated in FIG. 6B, when a printing displacement occurs and the color adjustment chart P1 is inclined from the ideal printing position, the printing position of the first register mark T1 is also inclined from the ideal printing position by the same inclination amount as that of the color adjustment chart P1.

The shape of the first register mark T1 is not limited to a rectangle, and other various shapes such as a triangle and a hexagon can be applied. Furthermore, although the first register mark T1 is painted solid black, the present invention is not limited thereto. For example, the first register mark T1 may be internally filled with white or painted any other color. Further, in order to be readable by the reading section 32, it is preferable that the first register mark T1 has a predetermined density difference from the sheet S1.

In addition, when the controller 26 determines that the patch size is larger than the predetermined size or the colorimetry mode is not the high-precision colorimetry mode (determination of NO in step S12), the controller 26 advances the process to step S14. In the processing of step S14, the controller 26 of the image forming apparatus 20 controls the image forming section 24 so as to print a register mark in the form of a cross as a predetermined second measurement image (second register mark T2). Then, the controller 26 advances the process to step S17.

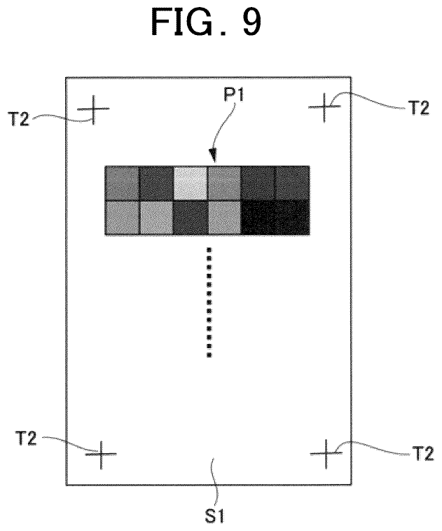

FIG. 9 is a diagram illustrating an image formed on the sheet S1 when the patch size is larger than the predetermined size or the colorimetry mode is not in the high-precision colorimetry mode (first level).

As illustrated in FIG. 9, when the patch size is larger than the predetermined size or the colorimetry mode is not the high-precision colorimetry mode, the color adjustment chart P1 and the second register marks T2 are printed on the sheet S1. Similarly to the first register marks T1, the second register marks T2 are printed at the four corners of the sheet S1. Each of the second register marks T2 is printed as a cross image. The second register mark T2 and the color adjustment chart P1 are formed at predetermined positions in the sheet S1.

Note that an example in which the second register mark T2 is formed on the sheet S1 at the first level, where the patch size is larger than the predetermined size or the colorimetry mode is not the high-precision colorimetry mode, has been described, but the present invention is not limited thereto. At the first level, the second register mark T1 may not be formed on the sheet S2.

In the processing of step S15, the controller 26 of the image forming apparatus 20 and the controller 31 of the image reading device 30 perform the patch measurement process. In the processing of step S15, the position and the size of the first register mark T1 are measured to measure the position and the size of the color adjustment chart P1. Note that details of the processing of step S15 will be described later.

When the processing of step S15 is completed, the controller 31 of the image reading device 30 determines whether the return value is an error (step S16). In the processing of step S16, when the controller 31 determines that the return value is an error (determination of YES in step S16), the controller 31 does not perform the colorimetry operation by the colorimetry section 34. That is, the control of the colorimetry section 34 by the controller 31 of the image forming system 1 according to the present embodiment includes control not performing the colorimetry operation. Then, the controller 31 advances the process to step S18.

To be specific, the controller 31 controls the conveyance section 36 to convey the sheet S1 to the first conveyance section 37. Therefore, the sheet S1 is ejected into the sheet ejection tray 39 without passing through the colorimetry section 34. Alternatively, the controller 31 controls the conveyance section 36 not to operate the colorimetry section 34 even when the sheet S1 is conveyed to the second conveyance section 38. Therefore, the sheet S1 is ejected into the sheet ejection tray 39 without being subjected to colorimetry by the colorimetry section 34.

Thus, by performing an error determination before operating the colorimetry section 34, an error can be quickly detected. In addition, when an error is detected, by not operating the colorimetry section 34, it is possible to avoid wasting time in the colorimetry section 34 and shorten the processing time.

If the controller 31 determines in the processing of step S16 that the return value is not an error (determination of NO in step S16), the controller 31 performs colorimetry processing (step S17). In the processing of step S17, the controller 31 controls the conveyance section 36 to convey the sheet S1 to the second conveyance section 38. Next, the controller 31 controls the sensing section 33 and the colorimetry section 34 to perform colorimetry on the color adjustment chart P1 printed on the sheet S1. This completes the colorimetry operation of the image forming system 1.

The colorimetry processing is performed without performing the processing of step S15 and step S16 when the patch size is larger than the predetermined size or the colorimetry mode is not the high-precision colorimetry mode. In a case where the patch size is relatively large, even when the color adjustment chart P1 is slightly inclined, the detection point Q1 of the colorimetry section 34 passes over the patch that is the original colorimetry target. Therefore, it is possible to shorten the processing time of the entire system by not performing the processing of step S15 and step S16 when the patch size is larger than the predetermined size or the colorimetry mode is not the high-precision colorimetry mode.

On the other hand, when the patch size is smaller than the predetermined size or the colorimetry mode is the high-precision colorimetry mode, the printing displacement, the patch size, and the like of the color adjustment chart P1 are determined before the colorimetry operation of the colorimetry section 34 is performed. As a result, an error determination can be performed before actually operating the colorimetry section 34, and the processing time of the entire system can be shortened.

Furthermore, in the processing of step S18, the controller 26 of the image forming apparatus 20 determines whether to perform position adjustment based on information on the processing of step S15 in the controller 31 of the image reading device 30. In the processing of step S18, if the controller 26 determines not to perform position adjustment (determination of NO in step S18), the controller 26 ends the process.

In the processing of step S18, if the controller 26 determines to perform position adjustment (determination of YES in step S18), the controller advances the process to step S19. In the processing of step S19, the controller 26 of the image forming apparatus 20 controls the image forming section 24 based on the information on the processing of step S15 in the controller 31 of the image reading device 30. That is, the controller 26 of the image forming apparatus 20 controls the image forming section 24 based on the information from the controller 31 of the image reading device 30 to adjust the printing positions of the color adjustment chart P1, and the register marks T1 and T2. Then, when the processing of step S19 is completed, the controller 26 returns the process to step S11 and performs the colorimetry operation again.

In the processing of step S19, an example in which the image forming apparatus 20 adjusts the position based on the information from the controller 31 of the image reading device 30 has been described, but the present invention is not limited thereto. For example, the information on the processing of step S15 may be displayed on the display part 22, and the user may operate the operation part 21 to perform the position adjustment.

Next, the patch measurement process in the processing of step S15 will be described with reference to FIGS. 5, 6A, 6B, 7, and 8.

As illustrated in FIG. 5, the controller 26 of the image forming apparatus 20 holds chart information to be printed in the storage section 27 (step S21). Next, the controller 26 controls the image forming section 24 to print the color adjustment chart P1 and the first register marks T1 on the sheet S1 based on the chart information held in step S21 (step S22). Thus, as illustrated in FIG. 6A and FIG. 6B, the color adjustment chart P1 and the first register marks T1 are printed on the sheet S1. Furthermore, the sheet S1 is conveyed from the image forming apparatus 20 to the image reading device 30.

When the sheet S1 is conveyed to the image reading device 30, the controller 31 of the image reading device 30 controls the reading section 32 to capture the color adjustment chart P1 and the first register marks T1 printed on the sheet S1 (step S23). When the processing of step S23 is completed, the reading section 32 outputs the captured image information to the controller 31. Next, the controller 31 calculates feature points of the color adjustment chart P1 and the first register marks T1 based on the image information (step S24).

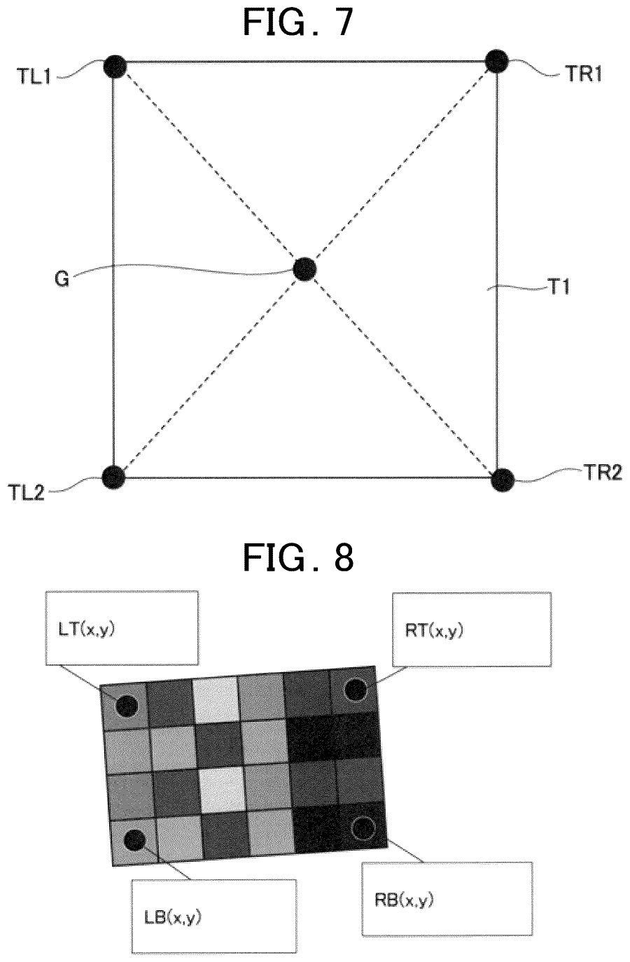

FIG. 7 is an explanatory diagram illustrating a method for calculating a feature point.

As illustrated in FIG. 7, the controller 31 detects, from the image information, two straight lines that bisect the area of the first register mark T1, which has a rectangular shape (e.g., a diagonal line connecting vertices TL1 and TR2 and a diagonal line connecting vertices TL2 and TR1). Then, the center of gravity G of the first register mark T1 is calculated as a feature point from the intersection of the two diagonal lines.

For example, based on the image information of the first register mark T1, the controller 31 first acquires a middle point in the main scanning direction. That is, the controller 31 acquires the total value of the density distribution for a specific size in the main scanning direction and calculates the middle point in the main scanning direction from the data of the total value. Next, the controller 31 acquires a middle point in the sub-scanning direction orthogonal to the main scanning direction, based on the image information of the first register mark T1. That is, the controller 31 acquires the total value of the density distribution for a specific size in the sub-scanning direction and calculates the middle point in the sub-scanning direction from the data of the total value. Then, the controller 31 calculates the center of gravity G of the first register mark T1 as a feature point from the intersection between the middle point in the main scanning direction and the middle point in the sub-scanning direction.

Here, when the intersection of the crossed lines (cross) is calculated as a feature point, as in the second register mark T2 illustrated in FIG. 9, the calculation accuracy of the feature point may decrease due to toner spillage, contamination, or the like. Therefore, calculating the center of gravity G of the rectangular first register mark T1 as a feature point can reduce the influence of toner spillage, contamination, or the like and improve the calculation accuracy.

Returning to FIG. 5, the controller 31 determines whether the centers of gravity of the respective four first register marks T1, that is, the four feature points have been calculated (step S25). In the processing of step S25, if the controller 31 determines that the four feature points cannot be calculated (determination of NO in step S25), the controller 31 performs an error notification (step S33). That is, the return value is an error in the patch measurement process. Then, the controller 31 advances the process to the processing of step S16 illustrated in FIG. 4.

If the controller 31 determines in the processing of step S25 that the four feature points have been calculated (determination of YES in step S25), the controller 31 calculates a displacement coefficient from the four feature points (step S26). In the processing of step S26, for example, a projective transformation coefficient is calculated as the displacement coefficient from the four feature points.

Next, the controller 31 calculates the coordinates of the four corners of the color adjustment chart P1 based on the displacement coefficient calculated in the processing of step S26 (step S27). In the processing of step S26 and step S27, for example, various calculation methods such as projective transformation, a phase only correlation, and affine transformation can be applied.

FIG. 8 is a diagram illustrating the coordinates of the four corners of the color adjustment chart P1.

By performing the processing of step S27, as illustrated in FIG. 8, the coordinates (x, y) of the four corners LT, LB, RT, and RB of the color adjustment chart P1 can be obtained. Next, the controller 31 calculates the differences (distances) in the XY components, that is, the displacement amounts from the ideal positions, from the coordinates (x, y) of the four corners LT, LB, RT, and RB of the color adjustment chart P1 (step S28). That is, as the differences in the Y component, LT(y)-RT(y) and LB(y)-RB(y) are calculated for the four corners. Similarly, as the differences in the X component, LT(x)-LB(x) and RT(x)-RB(x) are calculated for the four corners.

Next, the controller 31 determines whether each of the differences obtained in the processing of step S28 is within an allowable error (step S29). If the controller 31 determines in the processing of step S29 that the difference exceeds the allowable error (determination of NO in step S29), the controller 31 performs an error notification (step S34). That is, the return value is an error in the patch measurement process. Then, the controller 31 advances the process to the processing of step S16 illustrated in FIG. 4. Further, the controller 31 outputs the displacement amount calculated in step S29 to the controller 26 of the image forming apparatus 20. As a result, the printing displacement can be automatically corrected in step S19.

In the processing of step S29, if the controller 31 determines that the difference is within the allowable error (determination of YES in step S29), the controller 31 calculates the magnification of the color adjustment chart P1, that is, the patch size from the size of the first register mark T1 based on the image information (step S30). Next, the controller 31 determines whether the magnification obtained in the processing of step S30 is greater than or equal to a predetermined magnification (step S31).

If the controller 31 determines in the processing of step S31 that the magnification is not greater than or equal to the predetermined magnification (determination of NO in step S31), the controller 31 performs an error notification (step S35). That is, the return value is an error in the patch measurement process. Then, the controller 31 advances the process to the processing of step S16 illustrated in FIG. 4. On the other hand, in the processing of step S31, if the controller 31 determines that the magnification is greater than or equal to the predetermined magnification (determination of YES in step S31), the controller 31 notifies that the color adjustment chart P1 is normal (step S32). Next, the controller 31 advances the process to step S16 illustrated in FIG. 4. This completes the patch measurement process.

### 4. Modification Example of Feature Points

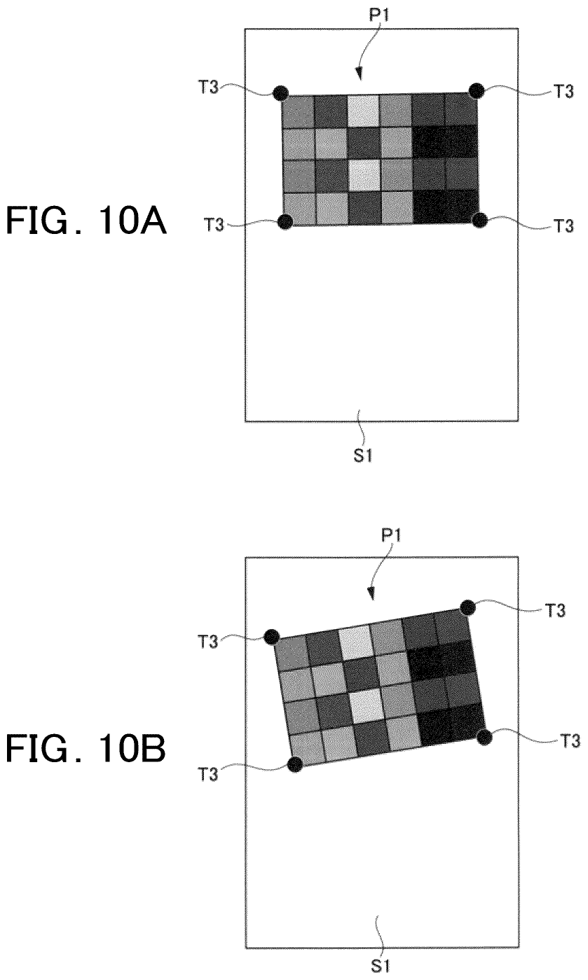

Next, a modification example of feature points will be described with reference to FIG. 10A and FIG. 10B.

FIG. 10A and FIG. 10B are explanatory diagrams illustrating a modification example of feature points. Note that FIG. 10A illustrates an ideal printing position, and FIG. 10B illustrates an image when a printing displacement occurs.

In the above-described embodiment, an example in which the center of gravity of the first register mark T1 having a rectangular shape is set as the feature point has been described, but the present invention is not limited thereto. For example, as illustrated in FIG. 10A, vertices T3 at the four corners of the color adjustment chart P1 printed on the sheet S1 may be set as feature points. As illustrated in FIG. 10B, when a printing displacement occurs and the color adjustment chart P1 is inclined from the ideal printing position, each of the vertices T3 at the four corners of the color adjustment chart P1 is inclined from the ideal printing position by the same inclination amount as that of the color adjustment chart P1. Even with such feature points, the displacement amount of the color adjustment chart P1 can be calculated as in the above-described embodiment.

The embodiment has been described above, including the operation and effectiveness thereof. However, the present invention is not limited to the above-described embodiment, and various modifications can be implemented without departing from the scope of the invention described in the claims.

Furthermore, although an example in which the sheet is applied as a recording medium has been described, the recording medium is not limited to this, and other various media such as film and fabric are applicable as the recording medium.

In addition, some or all of the constituent elements, functions, processing sections, and the like described above may be implemented by hardware by, for example, designing an integrated circuit. In addition, each of the above-described constituent elements, functions, and the like may be realized by software by a processor interpreting and executing a program for realizing each function. Information such as programs, tables, and files for implementing the respective functions may be stored in a storage device such as a memory, a hard disk, or a solid state drive (SSD), or a recording medium such as an IC card, an SD card, or a DVD.

Note that although the terms “parallel”, “orthogonal”, and the like are used in the present specification, these do not mean only “parallel” and “orthogonal” in a strict sense. The terms “parallel” and “orthogonal” may indicate, respectively, a state of “substantially parallel” and a state of “substantially orthogonal” within a range in which the functions can be exhibited, including a state of “parallel” and a state of “orthogonal”.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-084711 filed on May 24, 2024, is incorporated herein by reference in its entirety.

What is claimed is:

1. An image forming system comprising:
an image forming section that forms an image on a recording medium;
a reading section that reads the image formed on the recording medium;
a colorimetry section that
is disposed downstream of the reading section in a conveyance direction of the recording medium, and
performs colorimetry on a color adjustment chart formed on the recording medium; and
a hardware processor that controls the colorimetry section based on the image read by the reading section.

2. The image forming system according to claim 1, wherein the hardware processor
calculates a feature point from the image read by the reading section, and
controls the colorimetry section based on the feature point.

3. The image forming system according to claim 2, wherein the hardware processor determines, based on the feature point, whether to cause the colorimetry section to perform the colorimetry on the color adjustment chart.

4. The image forming system according to claim 3, wherein the feature point is calculated from a predetermined measurement image formed on the recording medium.

5. The image forming system according to claim 4, wherein the feature point includes a center of gravity of the predetermined measurement image.

6. The image forming system according to claim 2, wherein when the hardware processor determines that a patch size of the color adjustment chart is smaller than a predetermined size, the hardware processor causes the image formation section to form the feature point on the recording medium.

7. The image forming system according to claim 2, wherein:
the hardware processor includes a first level and a second level as a colorimetry mode for the colorimetry,
the second level being higher in precision of the colorimetry than the first level; and,
when determining that the colorimetry mode is the second level, the hardware processor causes the image formation section to form the feature point on the recording medium.

8. The image forming system according to claim 2, wherein the hardware processor
calculates, from the calculated feature point, a displacement amount of the color adjustment chart from an ideal position, and
determines, based on the calculated displacement amount, whether to cause the colorimetry section to perform the colorimetry on the color adjustment chart.

9. The image forming system according to claim 8, wherein, based on the calculated displacement amount, the hardware processor causes the image formation section to adjust a printing position of the color adjustment chart.

10. The image forming system according to claim 1, wherein the hardware processor
calculates a patch size of the color adjustment chart from the image read by the reading section, and
controls the colorimetry section based on the calculated patch size.

11. The image forming system according to claim 4, wherein the predetermined measurement image includes a rectangular image formed at each of four corners of the recording medium.

12. A method for controlling an image forming system, comprising:
forming an image of a color adjustment chart on a recording medium;
reading the image formed on the recording medium by a reading section; and
controlling a colorimetry section based on the image read by the reading section, the colorimetry section being disposed downstream of the reading section in a conveyance direction of the recording medium and being configured to perform colorimetry on the color adjustment chart formed on the recording medium.

13. A non-transitory computer-readable recording medium storing a program executable by a computer, the program causing an image forming system to execute:
causing an image forming section to form an image of a color adjustment chart on a recording medium;
causing a reading section to read the image formed on the recording medium; and
controlling a colorimetry section based on the image read by the reading section, the colorimetry section being disposed downstream of the reading section in a conveyance direction of the recording medium and being configured to perform colorimetry on the color adjustment chart formed on the recording medium.
